(19) United States
(12) Patent Application Publication
(10) Pub. No.: US 2015/0357738 A1
(43) Pub. Date: Dec. 10, 2015

(54) SOCKET CONTACT

(71) Applicant: HARTING ELECTRIC GMBH & CO. KG, Espelkamp (DE)

(72) Inventors: Sebastian GRIEPENSTROH, Rahden (DE); Timm MEYROSE, Rahden (DE); Fred BORGMANN, Luebbecke (DE); Heiko KOELLING, Huellhorst (DE); Burghard BLANKE, Rahden (DE)

(73) Assignee: Harting Electric GmbH & Co., KG, Espelkamp (DE)

(21) Appl. No.: 14/760,406

(22) PCT Filed: Nov. 6, 2013
(86) PCT No.: PCT/DE2013/100375

§ 371 Date: Jul. 10, 2015

(30) Foreign Application Priority Data
Jan. 18, 2013 (DE) 10 2013 100 493.8

(51) Int. Cl. H01R 13/187; H01R 43/16

(52) U.S. Cl. CPC H01R 13/187; H01R 43/16

(57) ABSTRACT

The invention relates to a socket contact for electrically contacting a pin contact, wherein the socket contact (1) is substantially formed from a hollow cylinder, into which at least one axial slot (3) is introduced, as a result of which at least two spring arms (4) are formed, wherein the ends of the spring arms (4) have contact regions (4b), wherein in each case two touch contacts (7) with the pin contact can be produced via the contact regions (4b), wherein the contact regions (4b) have a curved cover area (4c), wherein the curved cover area (4c) forms two touch contacts (7) with the pin contact.

The invention proceeds from a socket contact according to the preamble of claim 1. Further, the invention relates to a method for producing a socket contact according to claim 8.

Such socket contacts are needed for producing an electric contact with a pin contact.

Both on the socket contact and on the pin contact, electric conductors may be directly connected. Oftentimes, a conductor is connected to the socket or pin contact using crimp connection technology.

### PRIOR ART

DE 102010020346 A1 shows a contact socket with individual spring arms. The socket is made from solid material. Such a contact socket affords high contact forces with the associated pin contact. The contact force remains constant even after multiple plug-in operations.

EP 0 133 377 A2 shows a socket contact with two contact lamellae. The contact lamellae have a V shape and thus two touch contacts with a contact pin.

U.S. Pat. No. 5,135,418 A discloses a contact socket with contact lamellae, Each of the contact lamellae has two raised contact pins. By means of these two contact pins, two touch contacts with a pin contact are produced for each lamella.

U.S. Pat. No. 5,326,288 A shows a socket contact having contact lamellae that are bent inwards in the central area for contacting the pin contact.

U.S. Pat. No. 6,186,841 B1 shows a socket contact having six contact lamellae bent towards each other. The contact lamellae are bent in such a way that they form two touch contacts with contact elements of a certain size.

However, the drawback is the complex and therefore expensive production of such a socket contact.

### OBJECT OF THE INVENTION

It is the object of the invention to propose a low-cost socket contact that offers a reliable electric contact even after multiple plug-in cycles.

This object is achieved by means of the characterising features of claim 1.

Advantageous embodiments of the invention are indicated in the dependent claims.

The socket contact according to the invention is substantially formed from a hollow cylinder that has at least one axial slot introduced therein. As a result of the axial slot, at least two individual spring arms are formed.

Preferably, three axial slots are introduced into the hollow cylinder, as a result of which a total of six spring arms are formed. Such a number of spring arms has proven to be particularly advantageous. If more spring arms are provided, the spring elements, and thus the entire socket contact, become mechanically unstable. The spring arms easily deform during the plug-in process of the pin contact and it is not possible to carry out multiple plug-in operations with a consistent contact force, a consistent transition resistance, a consistent plug-in force etc. At least one of the above-mentioned properties will deteriorate after each plug-in operation.

According to the invention it is therefore provided for the spring arms to be equipped with contact regions, each of which has two touch contacts with a plugged-in pin contact. Each spring arm has two defined, spaced apart touch contacts on a pin contact. A touch contact is here to be understood to mean a touch zone on the spring arm, which is pressed onto the contact pin. The contact zone may take diverse two-dimensional geometries.

A socket with spring arms according to the invention has twice the number of touch contacts with a plugged-in contact pin as a conventional socket. The contact force between spring arms and the pin contact may be distributed over the individual touch contacts, which causes less wear and tear.

In order to achieve the same number of touch contacts with conventional sockets, twice the number of spring arms has to be provided. As a result, the spring arms become less rigid and will deform during the plug-in process of the pin contact and/or as early as during transport as bulk goods.

A method for producing a socket contact as described above proceeds as follows: from a cylinder-shaped base body made from a solid material, material is removed from the base body in conjunction with a relieving method and a wobbling method. In addition, so-called impact and broaching operations are carried out. What is crucial is that within the contact region of the spring arm, less material is removed than outside of the contact region. In the base body thus processed, at least one, however preferably three axial slots are introduced, as a result of which the individual lamellae are formed. The method is carried out in such a way that the spring arm has a greater wall thickness within the contact region than outside of the contact region. This production method is efficient and ensures a consistently high quality.

The contact regions are localised on the free ends of the spring elements. As a result, the contact with the plugged-in contact pin is produced in the vicinity of the plug-in opening of the contact socket.

It is particularly advantageous if the spring arms are bent towards each other in a radial direction. The spring arms are bent towards each other in the position in which also the contact regions are located.

Advantageously, the contact region of the spring arm is formed in such a way that it has a point in the circumferential direction, the radius of curvature of which is smaller than the radius of curvature of the points on the same plane. In the various planes, the points are located on a common axial axis of the spring arm. In the present application, this axial axis will also be referred to as the axis of curvature. The two touch contacts between the spring arm and the contact pin are then located to the left and to the right of this axis, but never on top of it.

Particularly advantageously, the contact region has at least two points, the radii of curvature of which are smaller than the radius of the pin contact to be inserted. These two points form the touch contacts between the spring arm and the contact pin.

In the end region of each spring arm, a so-called contact region is located. In this contact region, two touch contacts with a plugged-in pin contact are formed.

Advantageously, the wall thickness of the spring arms varies in an axial direction. This may be readily realised via the above-described production process. As a result, the physical properties of the individual spring arms, for example the spring constant, may be adjusted in a targeted manner.

Facing towards the contact pin, the contact region has a cover area that establishes the touch contact with the contact pin.

Advantageously, the wall thickness of the spring arms is greatest in the contact region. The contact region is ideally formed as a truncated pyramid with a rectangular base area. The cover area of the pyramids includes the contact regions and touch contacts as described above. Each of the base area and the cover area of the truncated pyramid are formed to be curved or bent. The curvature of the cover area and the base area, however, are formed differently.

### EMBODIMENT EXAMPLE

An embodiment example of the invention will be explained in more detail below with reference to the drawings, wherein:

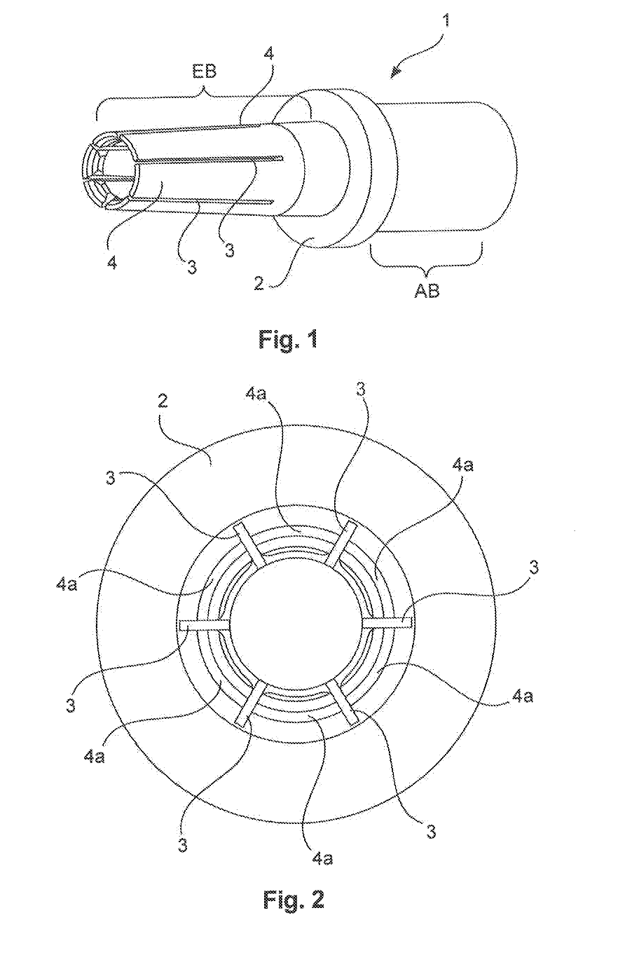

FIG. 1 shows a perspective view of a socket contact,

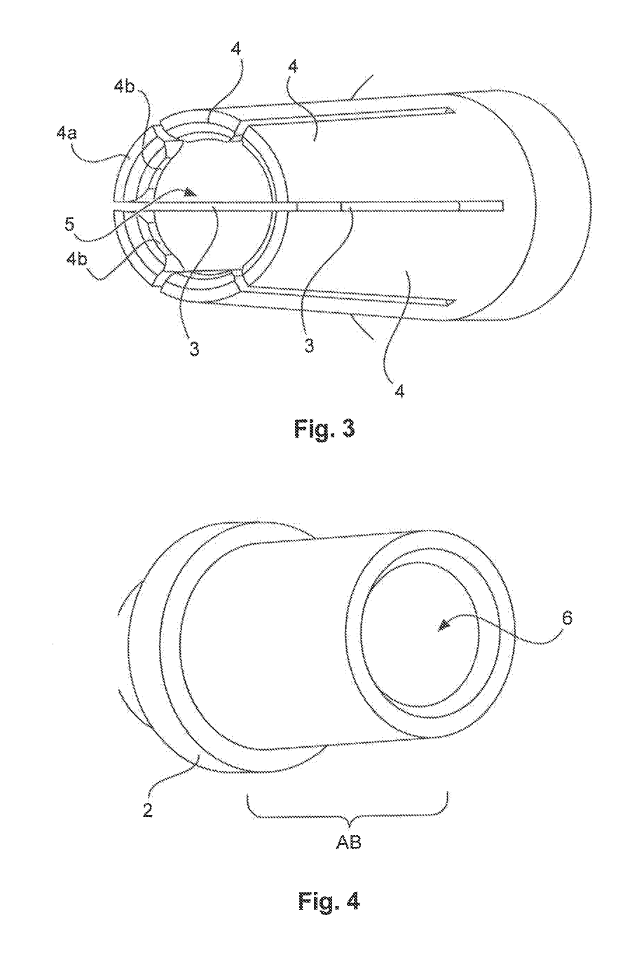

FIG. 2 shows a top view of a plug-in opening of the socket contact,

FIG. 3 shows a perspective view of the plug-in region of the socket contact with a view towards the plug-in opening, and

FIG. 4 shows a perspective view of the connection region of the socket contact, and

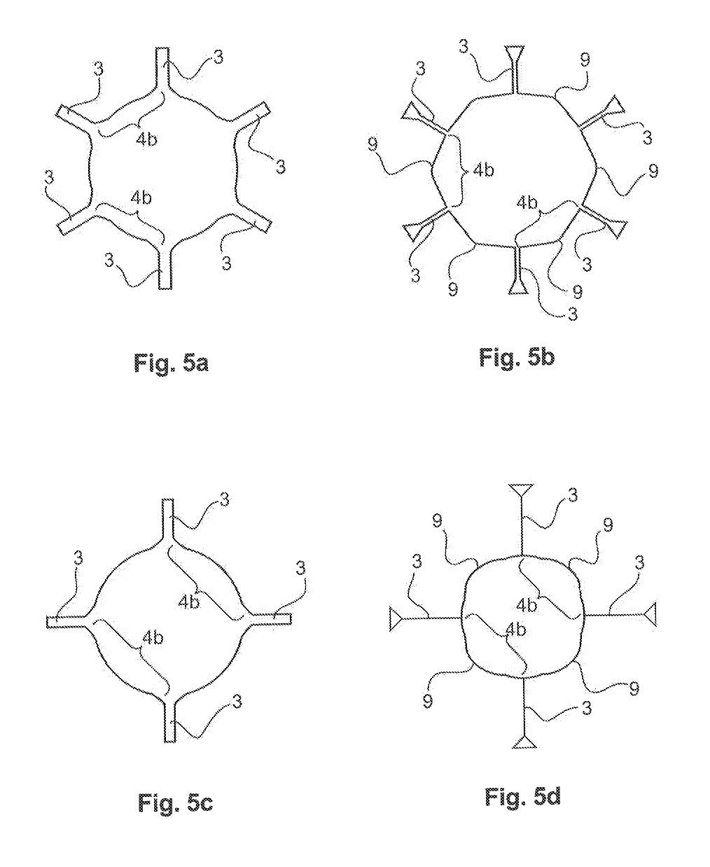

FIG. 5a-d show a radial section through the contact region of the socket contact.

FIG. 1 shows a perspective view of an embodiment example of a socket contact 1 according to the invention. The socket contact 1 substantially consists of a hollow cylinder made from a conductive material such as metal sheet. Alternatively, the socket contact may be machined from solid material. The hollow cylinder is interrupted by a circumferential thickening 2 provided approximately at the centre and separating the connection region AB from the plug-in region EB. The thickening 2 serves to position the socket contact in an insulating body of a plug-in connector.

In the plug-in region EB of the hollow cylinder, axial slots 3 are introduced, so that the individual spring arms 4 are formed. The ends 4a of the spring arms 4 are bent towards each other in the radial direction. In the embodiment example shown here, the ends 4a of the spring arms 4 surround the plug-in opening 5 of the contact socket 1.

At the ends 4a of the spring arms 4, contact regions 4b facing inwards in the radial direction are moulded, In the embodiment example shown here, the contact regions 4b are formed as a truncated pyramid.

The connection region AB of the socket contact 1 has a connection opening 6, into which a conductor of a cable can be inserted. The conductor (not shown) may be connected to the socket contact by way of a crimping process.

The contact region 4b is formed in such a way that two points 7 are provided, the radii of curvature of which are smaller than the radius of the pin contact to be inserted (not shown). These two points form the touch contacts between the spring arm 4 and the contact pin.

The contact region 4b is located in the upper area of the respective spring arm 4. Within the contact region 4b, the spring arm has a greater wall thickness than outside of the contact region 4b. This means that the spring arm 4 forms a thickening in the contact region. The contact region 4b substantially extends between the axial slots 3.

FIGS. 5a-d each show a section through the contact region of a socket contact in the radial plane. The shape and in particular the bent contact region 4b of the respective truncated pyramids 8 may be different, The contact region 4b is provided, at the end of each lamella 4, as a type of thickening with a certain geometric shape. Facing towards the contact pin, the contact region 4b has a bent or curved cover area 4c that establishes the touch contact with the contact pin.

FIG. 5a shows a socket contact with six axial slots 3 and six lamellae 4 with a contact region 4b. The contact region has a single bend.

The embodiment according to FIG. 5b discloses a more complex contact region 4b. Here, the contact region 4b has multiple bends, as a result of which each lamella 4 forms a pronounced notch 9. If one was to regard the notches as corner points, then the section would here form a regular hexagon. A direct connecting line between adjacent notches in the circumferential direction would form the shape of a hexagon.

The embodiment of the socket contact according to 5d also shows an interesting sectional shape. Here, too, a notch can be seen. If one was to regard this notch again as an imaginary corner point, one could see a quadrangle or a square. A direct connecting line between adjacent notches in the circumferential direction would form the shape of a quadrangle or a square.

The sectional shapes in FIGS. 5a and 5c are rather circular. The lamellae 4 according to embodiments 5b and 5d have multiple bends.

### LIST OF REFERENCE NUMERALS

1 Socket contact
2 Thickening
3 Axial slot
4 Spring arm
4a End of the spring arm
4b Contact region
4c Cover area of the contact region
5 Plug-in opening
6 Connection opening
7 Touch contact
8 Truncated pyramid
9 Notch

1. A socket contact for electrically contacting a pin contact, wherein the socket contact (1) is substantially formed from a hollow cylinder, into which at least one axial slot (3) has been introduced, as a result of which at least two spring arms (4) are formed, wherein the ends of the spring arms (4) have contact regions (4b), wherein in each case two touch contacts (7) can be produced with the pin contact via the contact regions (4b),
characterised in
that the contact regions (4b) have a curved cover area (4c),
and in that the curved cover area (4c) forms two touch contacts (7) with the pin contact.

2. The socket contact according to claim 1,
characterised in that
the spring arm has a greater wall thickness within the contact region (4b) than outside of the contact region.

3. (currently amended.) The socket contact according to claim 1,
characterised in that
the over area (4c) has a notch (9).

4. The socket contact according to claim 1,
characterised in that
the spring arms (4) are bent towards each other in the radial direction.

5. The socket contact according to claim 1,
characterised in that
the spring arms (4) have is wall thickness that varies in the axial direction.

6. The socket contact according to claim 1
characterised in that
the wall thickness of the spring arms (4) varies multiple times in the axial direction.

7. The socket contact according to claim 1,
characterised in that
the wall thickness of the spring arms (4) is greatest in the contact region (4b).

8. A method for producing a socket contact from a cylinder-shaped base body from solid material,
characterised in
that the socket contact is produced in conjunction with a relieving method and a wobbling method,
and in that impact and broaching operations are additionally carried out
and in that within the contact region. of the spring arm, less material, is removed than outside of the contact region,
and in that at least one, however preferably three axial slots are introduced.
